(19) United States
(12) Patent Application Publication
(10) Pub. No.: US 2006/0078699 A1
(43) Pub. Date: Apr. 13, 2006

(54) Insulation board with weather and puncture resistant facing and method of manufacturing the same

(76) Inventors: Kurt O. Mankell, Blue Bell, PA (US); Murray S. Toas, Norristown, PA (US); Jeffrey F. Juzaitis JR., West Chester, PA (US); Stephen Archibald, Philadelphia, PA (US); John E. Jeffers, King of Prussia, PA (US)

Correspondence Address: DUANE MORRIS, LLP;IP DEPARTMENT, 30 SOUTH 17TH STREET, PHILADELPHIA, PA, 19103-4196, US

(21) Appl. No.: 10/963,495

(22) Filed: Oct. 12, 2004

(51) Int. Cl. B32B 27/10

(52) U.S. Cl. 428/34.2

(57) ABSTRACT

An insulation board product is provided comprising a insulation board layer having a first major surface corresponding to or proximate to a contact or airflow surface and a second major surface opposite the first major surface. A weatherproof barrier layer is applied to the insulation board layer and a bridging contact layer is coupled between the second major surface and the weatherproof barrier layer.

### FIELD OF THE INVENTION

The present invention relates to insulation boards for providing weather and wear protection to ducts and tanks.

### BACKGROUND OF THE INVENTION

Exterior ducting, such as metal ducting on roofs of commercial properties, is often exposed to the elements. For this reason, thermal insulation boards may be installed around the ducting to provide both insulation and protection against weather. In one prior art practice, the thermal insulation boards are installed around the periphery of the ducting, in a manner familiar to those in the art. Thereafter, in a separate step, a weatherproof barrier is installed onto the exterior surface of the installed boards. Examples of weatherproof barriers include metal sheeting, glass fabric and mastic, foil/butyl rubber laminates and foil/polyester laminates. Some of these weatherproof barriers and methods of making the same are described in co-pending, commonly assigned U.S. patent application Ser. No. 10/719,912 entitled “Faced Mineral Fiber Insulation Board With Integral Glass Fabric Layer” filed Nov. 20, 2003, the entirety of which is hereby incorporated by reference herein.

A specific example of a prior art weather barrier is the FLEX-CLAD 400™ weatherproofing membrane available from MFM Building Products Corp. of Coshocton, Ohio. The FLEX-CLAD membrane includes a top layer of stucco-embossed, UV-resistant aluminum. Under the aluminum layer is a double layer of high density polyethylene reinforcement. Under the polyethylene is a uniform layer of rubberized asphalt adhesive covered by a removable silicone release paper. In application, an insulation board is applied to ducting, and the release paper of the FLEX-CLAD membrane is removed to expose the asphalt adhesive. The adhesive is then pressed to the exterior surface of the pre-installed insulation board to adhere the membrane thereto. Any gaps or seems are then sealed with a tape.

Alternatively, there have been reports of a weatherproof membrane being applied to an insulation board in the field before installation of the insulation board. The combined weatherproof membrane and insulation board are then installed around the ducting.

The installation process described above can be very labor intensive in that it requires at least two attachment processes in the field, i.e., attachment of the insulation boarding to the ducting and separate attachment of the weather barrier membrane to the ducting.

Improved weatherproofing systems including insulation board are desired, as well as improved methods of manufacturing the same.

### SUMMARY OF THE INVENTION

An insulation board product is provided comprising an insulation board layer having a first major surface corresponding to or proximate to a contact or airflow surface and a second major surface opposite the first major surface. A weatherproof barrier layer is applied to the insulation board layer and a bridging contact layer is coupled between the second major surface and the weatherproof barrier layer.

In one embodiment, the insulation board layer is formed from a fibrous material bound with a resin binder. The weatherproof barrier layer includes a foil-polymer laminate comprising at least three layers of foil and at least two polymer layers disposed therebetween. The bridging contact layer includes a paper layer coupled between and directly to the second major surface and the weatherproof barrier layer. A nonwoven mat facing may be coupled to the first major surface of the insulation layer. In one embodiment, the paper layer is coupled to the second major surface and the weatherproof barrier layer with a first and second adhesive layers, respectively. The first adhesive layer includes a liquid adhesive that penetrates the insulation layer and preferably the paper layer to provide more than just surface layer bond between the insulation layer and the paper layer.

The insulation board product has a pre-installed weather barrier, thereby providing significant labor savings by eliminating or greatly reducing the need to apply a weather barrier to a duct board in the field as described in the Background of the Invention section. The product can be applied to interior or exterior ducting or tanks in a manner known to those skilled in installing duct boards to such structures. Still further, the insulation board product can be formed into a tubular duct shape capable of conducting air, with the first major surface on an interior thereof and the weatherproof barrier layer on an outside thereof.

A method of forming the insulation board product is also provided. An insulation board is first formed. The insulation board is conveyed and a weatherproof barrier layer is provided to the conveyed insulation board layer. A bridging contact layer is disposed between the second major surface and the weatherproof barrier layer. The bridging contact layer and the weatherproof barrier layer are adhered to the insulation board layer.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a side elevation view of an exemplary embodiment of an insulation board product;

FIG. 1A is an enlarged view of a portion 1A of the product of FIG. 1;

FIG. 2 is a schematic side elevation view of an exemplary embodiment of a process for making the product of FIG. 1;

FIG. 3 is a schematic side elevation view of an alternative embodiment of a process for making the product of FIG. 1; and

FIG. 4 is an isometric view of a duct board folded into an air duct.

### DETAILED DESCRIPTION

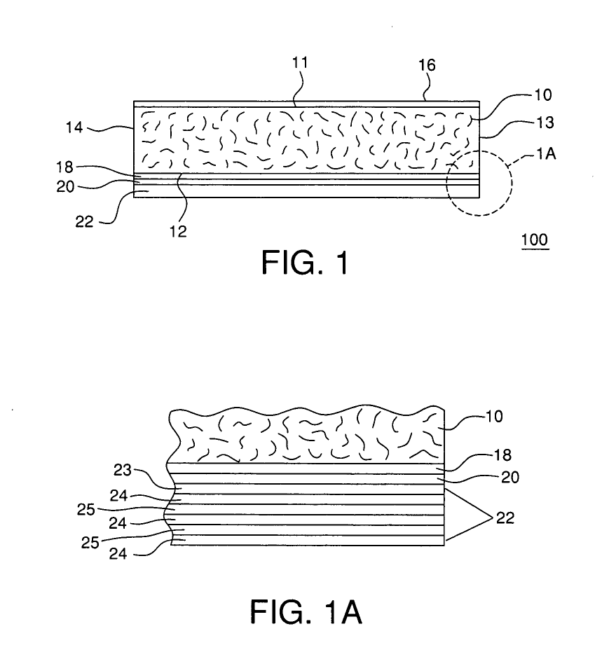

Provided herein is an insulation board product having a weather barrier facing thereon and methods of manufacturing the same. FIG. 1 is a side elevation view of an insulation board product 100 including a weather barrier layer. In a preferred embodiment, the product 100 includes an insulation board layer 10 having a first and second major surfaces 11, 12, respectively and side surfaces 13, 14. First major surface 11 is also referred to herein as an “air flow” or “contact surface”, as first major surface 11 (unless covered by a nonwoven layer 16, for example) forms the interior surface of a duct when product 100 is formed into an air duct or contacts ducting when product 100 is applied to ducting to provide insulation and weather resistance.

Insulation board layer 10 is preferably a rigid or semi-rigid board having a density between about 1.5-6.0 lb/ft³ (0.7-2.7 kg/m³). These boards customarily are produced as sheets typically having a thickness in the range of about 0.25-4.0 inches, and more preferably about 0.5-4.0 inches, and about 2-4 feet wide by about 4-12 feet in length. Insulation board 10 is preferably formed from organic fibers such as polymeric fibers or inorganic fibers such as rotary glass fibers, textile glass fibers, stonewool (also known as rockwool) or a combination thereof. Mineral fibers, such as glass, are preferred. In an exemplary embodiment, the insulation board 10 is formed from glass fibers bound together with a heat cured binder, such as a resinous phenolic material like phenolformaldehyde resins or phenol urea formaldehyde (PUFA). Melamine formaldehyde, acrylic, polyester, urethane and furan binder may also be utilized in some embodiments. Conventional insulation boards typically have about 6-15% or less of their dry weight attributable to the heat cured binder.

In one embodiment, the product 100 includes a non-woven facing layer 16 that protects at least the first major surface 11, and optionally side surfaces 13, 14, of the duct board 10. In one embodiment, the nonwoven layer 16 comprises glass fibers bonded together by an adhesive.

The details of forming insulation board 10 are known to those in the art and are not repeated herein so as to avoid obscuring the present invention. An exemplary method of forming an insulation board layer is detailed in commonly assigned, copending U.S. patent application Ser. No. 10/798,184 filed Mar. 11, 2004, entitled “Faced Fiberglass Board With Improved Surface Toughness”, the entirety of which is hereby incorporated by reference herein.

Product 100 includes a weatherproof barrier 22 (also referred to as “weatherproofing”) proximate to its second major surface 12. Weatherproofing is usually defined as the elimination of above grade openings to resist the flow of rain water. “Above grade” means above ground, i.e., dealing with openings in non-basements, i.e., with walls, roofs, windows, doors and outdoors HVACs ducts. As better illustrated in the enlarged partial view of FIG. 1A, weatherproof barrier 22 preferably comprises a foil-polymer laminate. In one embodiment, weatherproof barrier 22 preferably includes at least three foil layers 24, such as aluminum, separated by two polymer layers 25, such as polyester. Foil layers 24 and polymer layers 25 are secured together by adhesive layers (not shown).

In an exemplary embodiment, weather barrier 22 is the VENTURECLAD™ 1577 series five-ply, laminated aluminum foil/polyester film facing available from Venture Tape Corp. of Rockland, Mass. The VENTURECLAD 1577 series barrier includes an acrylic pressure sensitive adhesive layer, shown in FIG. 1 as adhesive layer 23. In one embodiment, the weather barrier 22 is the plain aluminum 1577CW® barrier, the white aluminum 1577CW-W barrier or the 1577CW-E embossed plain aluminum barrier. Test results show that the thickness of the 1577CW and 1577CW-W products is about 0.0060″. Test results show that the thickness of the 1577CW-E product is about 0.0093″.

The product literature for the VENTURECLAD 1577CW weather barrier indicates that the weather barrier is an absolute vapor barrier, is weather resistant and has high puncture and tear resistance. The data sheet also indicates that the 1577CW product has the following characteristics: a tensile strength of 68 lb/inch width (as measured under PSTC-31 test); a puncture resistance of 35.4 lbs (as measured under ASTM D-1000 test); a water vapor permeance of 0 perm (no test method provided); a tear strength of 8.5 lbs (under ASTM D-624 test); “indefinite” sheer adhesion at 2.2 psi (as measured under PSTC-1 test); peel adhesion of 55 oz/in (under PSTC-1 test); an elongation at break of 166% (no test method provided); and a maximum continuous use temperature of 300° F. The product also exceeds all requirements of 25/50 flame/smoke rating under UL 723 testing methodology.

In contrast, vapor barrier layers such as FSK (Foil/Scrim/Kraft) layers are typically not considered weatherproof barriers, as they are relatively thin and fragile, offering little puncture and wear resistance, with paper making up about ⅓ of their composition. The thickness of the single layer of foil on, for example, the R-3070 FSK product from Lamtec Corporation of Flanders, N.J. is listed as 18 microns (0.0007″) in the product literature. This single foil top layer on FSK can typically be scratched away relatively easily.

In a preferred embodiment of the product 100, the pressure sensitive adhesive layer 23 is not used to directly couple the weather barrier 22 to the duct board 10. It is believed that a pressure sensitive adhesive layer does not form a good adhesive connection with, for example, the rough fiber glass surface 12 of the preferred duct board 10. Therefore, in one embodiment, a smooth bridging contact layer 20, preferably comprising a cellulosic paper layer, such as kraft paper, is disposed between major surface 12 and the barrier 22. Alternatively, bridging contact layer 20 may comprise a non-woven polymer fabric comprising, for example, polyester, polypropylene or polyester and rayon fibers. The bridging contact layer 20 forms a smooth planar surface for attachment of barrier 22 via pressure sensitive adhesive layer 23. In turn, bridging contact layer 20 is coupled to duct board 10 via adhesive layer 18. Adhesive layer 18 preferably comprises a non-releasable adhesive, such as a liquid, water-based adhesive that when dried forms a strong adhesive bond between the bridging contact layer 20 and the major surface 12. An exemplary adhesive is the Henkel 50-0965 MHV adhesive from Henkel Corporation of Düsseldorf, Germany, available through Henkel Adhesives of Elgin Ill., which is a water-based polyvinyl acetate adhesive. Other suitable water-based adhesives include, for example, Henkel product numbers 42-5001 and 57-7001 (both vinyl acetate/acrylate blend with rubber based technology), Henkel product number 57-6153M-2 (vinyl acetate/acrylate blend), and Henkel product number 57-0806 (vinyl acetate/acrylate emulsion). It is believed that an advantage of using a non-releasable adhesive, over a pressure sensitive adhesive, is that the non-releasable adhesive (e.g., liquid, water-based adhesive) penetrates into the insulation board 10 and the bridging contact layer 20 before it is dried, therefore providing more than just a surface layer bond available from a pressure sensitive adhesive 23.

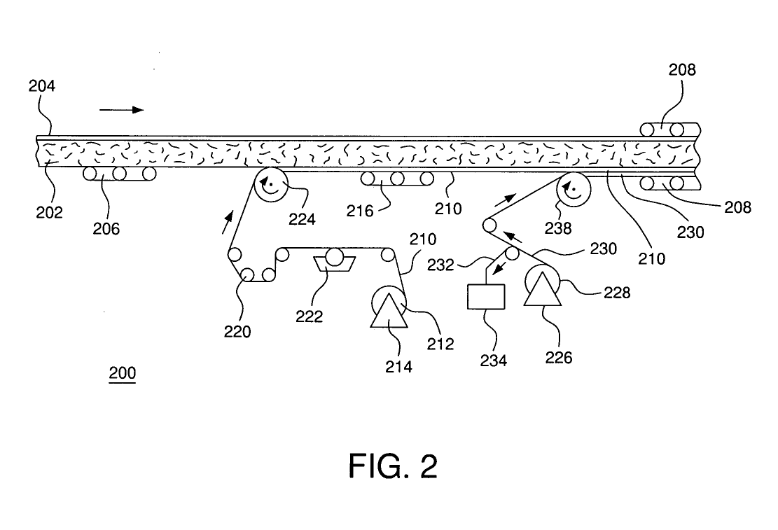

FIG. 2 is a schematic side elevational view of a system for making a product 100 as described above. At least one lane of cured insulation board 202 is presented by a feed conveyor system 206. In one embodiment, the insulation boarding 202 includes a nonwoven facing layer 204 adhered to a first major surface thereof. A roll 212 from payout stand 214 provides cellulosic material 210 through accumulator 220 for tensioning the cellulosic layer and roller 224 to a major surface of duct board 202. A water-based adhesive is provided to a side of layer 210 from adhesive well 222, a roll applicator or other application means, which is then oriented toward the second major surface of the insulation boarding 210 via accumulator 220 and roller 224. In this manner, a layer 210 is adhered to boarding 202 and provides an excellent surface for adhering a weather barrier thereto. A heated roller 216 may be provided to facilitate drying the adhesive applied to the layer 210.

In an embodiment when the water-based adhesives is applied with a roll coater, the adhesive is applied in a dry weight of approximately between 3 and 7 grams per square foot.

Once layer 210 is secured to the insulation layer 202, the weather barrier layer 230 is provided from a roll 228 on payout stand 226. In one embodiment, such as where the layer 230 is the VENTURECLAD™ 1577CW® five-ply, laminated aluminum foil/polyester film facing described above, a release layer 232 is removed from over a pressure sensitive adhesive layer on the surface of barrier layer 230 and collected in collection area 234, thereby exposing the pressure sensitive adhesive, which is oriented toward layer 210 via an accumulator and roller 238. Roller 238 and compression conveyors 208 then compress layers 202, 210 and 230, forming a lane of product 100 described above. The lane 100 may be cut to size as desired.

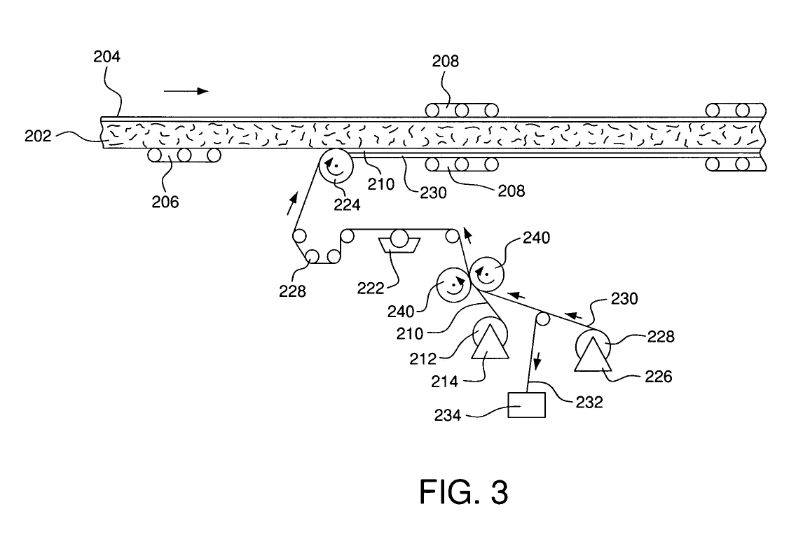

In an alternative embodiment shown in the schematic side elevational view of the system of FIG. 3, the cellulosic layer 210 and weather barrier layer 230 are adhered together via the pressure sensitive adhesive layer on barrier layer 230 before the layer 210 is adhered to the board layer 202. In this embodiment, after the release layer 232 is removed to expose the pressure sensitive adhesive, the weather barrier layer 230 and bridging contact layer 210 are brought into contact and coupled together by compression rollers 240. The remainder of the process and the system are as described above in connection with FIG. 2, only the combined layer is adhered to layer 202 via adhesive supplied from well 222 and with roller 224 and compression conveyor 208. Compression rollers 208 may be heated to facilitate drying of the water-based adhesive. Although not shown, the product may also be cut to a desired width and length using techniques familiar to those in the art.

In an alternative embodiment, the weather barrier layer is provided from a payout stand with a bridging contact layer already laminated to the weather barrier layer with an adhesive layer. In one exemplary embodiment, the weatherbarrier layer is VENTURCLAD 1577WK weather barrier, which is identical to the 1577CW-W weather barrier, only with a kraft layer pre-adhered to the foil/polymer laminate by an adhesive layer. Tests show that the thickness of the 1577WK product is about 0.0063″. Alternatively, this weather barrier layer may be the VENTURECLAD 1577EK weather barrier, which is identical to the 1577CW-E weather barrier only with a kraft layer pre-adhered to the foil/polymer laminate by an adhesive layer. Tests show that the thickness of the 1577EK product is about 0.0084″. In this embodiment, no release liner is needed. The adhesive layer, e.g., Henkel 50-0965 MHV, is then applied directly to the bridging contact layer (e.g., kraft paper layer), which is then coupled to the insulation product.

Alternatively, the weather barrier layer could be provided with no pressure sensitive adhesive and no kraft paper bridging contact layer. As a part of the process, a kraft paper bridging contact layer could be coupled to the weather barrier layer via a spray applied hot melt adhesive, such as Henkel #80-8273, during the manufacturing process.

In yet another alternative embodiment, where the weather barrier layer 22 is provided without a pressure sensitive adhesive layer 23 and no paper bridging layer, the weather barrier layer 22 is coupled directly to the major surface 12 of the board 10 without use of a bridging contact layer 20 using a non-releasable adhesive, such as a liquid, water-based adhesive that when dried forms a strong adhesive bond between the one of the foil layers 24 and the major surface 12. In one embodiment, the adhesive is HB Fuller V3484 water-based adhesive available from HB Fuller Co. of St. Paul, Minn.

The product 100 and method of making the same provide an insulation board product that has a pre-installed weather barrier, thereby providing significant labor savings by eliminating or greatly reducing the need to apply a weather barrier to an insulation board in the field as described in the Background of the Invention section. The product can be applied to metal ducting or tanks (not shown) in a manner known to those skilled in installing insulation boards to such structures. Although described for use in connection with exterior ducting and tanks, the product may also be used with interior structures, such as under a roof, between walls and in basements, wherein puncture resistance and/or moisture resistance is needed.

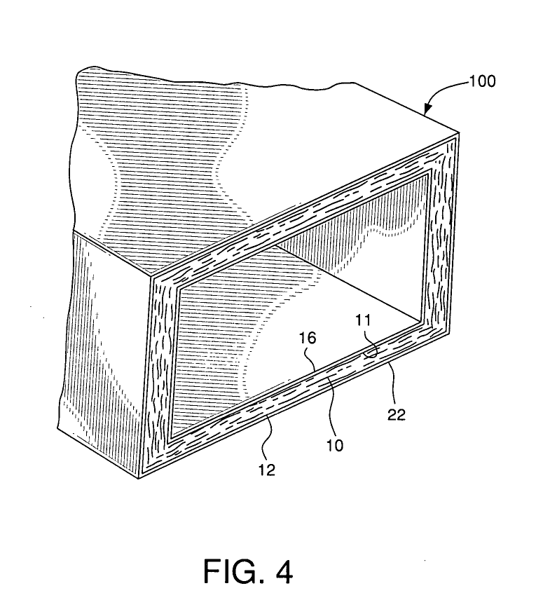

Still further, as shown in FIG. 4, one or more of the board product 100 can be formed into a tubular shape capable of conducting air, with the first major surface 11 on an interior thereof and the weatherproof barrier layer 22 on an outside thereof. Techniques for forming duct boarding into tubular ducts are not repeated in detail herein, as they are well known in the industry. Briefly though, three longitudinal grooves are cut into the duct board to facilitate bending of the product three times to form a tubular shape. Ship laps may be cut into the longitudinal edges of the product to allow connection thereof. In this embodiment, the weatherproof barrier layer is provided preferably substantially coextensive with the second major surface of the duct board layer so that the weatherproof barrier layer covers at least one corner formed in said tubular shape, and preferably three corners comprising the three bends formed in the duct board layer.

In one embodiment, insulation board 10 includes the insulation layer from the CRIMPWRAP™ Crimped Pipe and Tank Wrap available from CertainTeed Corporation of Valley Forge, Pa. This product is typically used to insulate vessels, large diameter pipes and rectangular or round duct work. The CRIMPWRAP product is available in thicknesses of 1-4 inches, lengths from 13-52 feet and is made from a continuous fiber glass blanket with variably-oriented glass fibers firmly bonded together with a thermosetting resin. The commercial product includes a facing laminated to the fiberglass layer with a low melting temperature polyethylene layer serving as an adhesive. In an embodiment of the present invention, the weather barrier layer, such as the various VENTURCLAD weather barrier layers, described above, would replace the existing facing on the CRIMPWRAP product and be secured to the insulation layer by the polyethylene layer, with or without a separate bridging layer.

In one embodiment, a layer of polyethylene or other thermoplastic is extruded and deposited on a surface of a weatherproof barrier layer. The layer is then cooled and the barrier layer is rolled for use in a manufacturing process as described above. The rolled barrier layer with the polyethylene is then provided in the manufacturing process from a payout stand and brought into contact with a heated roller or other heat source for softening the polyethylene layer thereon. The softened polyethylene layer is then brought into contact with a major surface of conveyed insulation layer, such as the insulation layer of a CRIMPWRAP product described above, and the lamination is compressed and cooled to promote adhesion of the weatherproof barrier layer and the insulation layer.

The CRIMPWRAP product insulation layer is also typically softer than a standard board product, with less fiber density and less binder. Therefore, in one embodiment, although not necessarily preferred, the VENTURECLAD weather barrier layer is coupled directly to the insulation layer via a pressure sensitive adhesive.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention

What is claimed is:

1. An insulation board product comprising:
a insulation board layer comprising a first major surface corresponding to or proximate to a contact or airflow surface and a second major surface opposite said first major surface;
a weatherproof barrier layer applied to said insulation board layer; and
a bridging contact layer coupled between said second major surface and said weatherproof barrier layer.

2. The product of claim 1, wherein said weatherproof barrier layer comprises at least one layer of foil and at least one polymeric layer.

3. The product of claim 1, wherein said weatherproof barrier layer comprises a foil-polymer laminate comprising at least three layers of foil and at least two polymer layers disposed therebetween.

4. The product of claim 3, wherein said polymer layers comprises polyester.

5. The product of claim 1, wherein said bridging contact layer comprises paper.

6. The product of claim 1, wherein said bridging contact layer comprises polyethylene.

7. The product of claim 1, wherein said bridging contact layer is coupled directly to said second major surface and said weatherproof barrier layer by a first and second adhesive layers, respectively.

8. The product of claim 7, wherein said first adhesive layer comprises a water-based adhesive.

9. The product of claim 1, further comprising a water repellant mat facing comprising a non-woven fiber material adhered to said first major surface.

10. The product of claim 1, wherein the product is formed into a tubular shape capable of conducting air, with the first major surface facing inward and the second major surface facing outward.

11. The product of claim 10, wherein said weatherproof barrier layer is substantially coextensive with said second major surface, such that said weatherproof barrier layer covers at least one corner formed in said tubular shape.

12. The product of claim 1, wherein said insulation board layer comprises randomly oriented inorganic fibers bonded together with an adhesive, said insulation layer having a weight of between about 1.5-6.0 pounds per cubic foot and a thickness between about 0.5-4.0″.

13. A method of forming an insulation board product, comprising:
forming an insulation board layer comprising a first major surface corresponding to or proximate to a contact or an airflow surface and a second major surface opposite said first major surface;
conveying said insulation board layer;
providing a weatherproof barrier layer to said conveyed insulation board layer;
disposing a bridging contact layer between said second major surface and said weatherproof barrier layer; and
adhering said bridging contact layer and said weatherproof barrier to said insulation board layer.

14. The method of claim 13, wherein said weatherproof barrier layer comprises at least one layer of foil and at least one polymeric layer.

15. The method of claim 13, wherein said weatherproof barrier layer comprises a foil-polymer laminate comprising at least three layers of foil and at least two polymer layers disposed therebetween.

16. The method of claim 15, wherein said polymer layers comprises polyester.

17. The method of claim 13, wherein said bridging contact layer comprises paper.

18. The method of claim 13, wherein said bridging contact layer is coupled directly to said second major surface and said weatherproof barrier layer by a first and second adhesive layers, respectively.

19. The method of claim 18, wherein said bridging contact layer is coupled to said weatherproof barrier layer by said second adhesive layer before said bridging contact layer is coupled to said insulation board layer, the method further comprising the step of coupling the combined bridging contact layer and weatherproof barrier layer structure to said insulation board layer with said first adhesive layer.

21. The method of claim 19, further comprising the steps of providing said second adhesive layer and coupling said bridging contact layer to said weatherproof barrier layer with said second adhesive layer.

22. The method of claim 18, wherein said bridging contact layer is coupled to said insulation board layer by said first adhesive layer before said bridging contact layer is coupled to said weatherproof barrier layer, the method further comprising the step of coupling the weatherproof barrier layer structure to the combined bridging contact layer and insulation board layer structure using said second adhesive layer.

23. The method of claim 18, wherein said first adhesive layer comprises a water-based, liquid adhesive.

24. The method of claim 13, wherein said weatherproof barrier layer is provided from a roll, said weatherproof barrier layer having said bridging contact layer adhered thereto prior to being provided from said roll.

25. The method of claim 13, further comprising the step of adhering a water repellant mat facing to said first major surface comprising a non-woven fiber material.

26. The method of claim 13, further comprising forming said insulation product in a tubular shape capable of conducting air, with the first major surface on an interior thereof and said weatherproof barrier layer on an outside thereof.

27. The method of claim 26, wherein said weatherproof barrier layer is substantially coextensive with said second major surface, such that said weatherproof barrier layer covers at least one corner formed in said tubular shape.

28. An insulation board product comprising:
an insulation board layer formed from fibrous material bound with a resin binder, said insulation board layer comprising a first major surface corresponding to or proximate to a contact or airflow surface and a second major surface opposite said first major surface;
a weatherproof barrier layer applied to said insulation board layer, said weatherproof barrier layer comprising a foil-polymer laminate comprising at least three layers of foil and at least two polymer layers disposed therebetween;
a paper layer coupled between and directly to said second major surface and said weatherproof barrier layer, wherein said paper layer is coupled to said second major surface and said weatherproof barrier layer with a first and second adhesive layers, respectively, said first adhesive layer comprises a non-releasable adhesive; and
a nonwoven mat facing coupled to said first major surface.

29. The product of claim 28, wherein the product is formed in a tubular shape capable of conducting air, with the mat facing on an interior thereof and said weatherproof barrier layer on an outside thereof.

30. The product of claim 29, wherein said weatherproof barrier layer is substantially coextensive with said second major surface, such that said weatherproof barrier layer covers at least one corner formed in said tubular shape.

31. The product of claim 26, wherein said insulation board layer has a weight of between about 1.5-6.0 pounds per cubic foot and between about 0.5-4.0″ thick.

32. An insulated duct or tank, comprising:
a duct or tank; and
at least one insulation board product secured to said duct or tank, said insulation board product comprising:
an insulation board layer comprising a first major surface facing said duct or tank and a second major surface opposite said first major surface;
a weatherproof barrier layer applied to said insulation board layer; and
a bridging contact layer coupled between said second major surface and said weatherproof barrier layer.
